(19) United States
(12) Patent Application Publication
(10) Pub. No.: US 2019/0042457 A1
(43) Pub. Date: Feb. 7, 2019

(54) CACHE (PARTITION) SIZE DETERMINATION METHOD AND APPARATUS

(71) Applicant: Intel Corporation, Santa Clara, CA (US)

(72) Inventors: Kshitij A. Doshi, Tempe, AZ (US); Bhanu Shankar, Pleasanton, CA (US); Vineet Singh, Hillsboro, OR (US)

(21) Appl. No.: 16/109,228

(22) Filed: Aug. 22, 2018

(51) Int. Cl. G06F 12/0893

(52) U.S. Cl. CPC G06F 12/0893; G06F 2212/1044

(57) ABSTRACT

Apparatuses, methods and storage medium associated with workload working set size determination, are disclosed herein. In embodiments, at least one computer-readable storage medium includes instructions stored therein to cause an apparatus to intermittently sample memory access operations associated with execution of a workload; generate a trace of memory addresses of the memory access operations sampled; generate a profile of average memory footprints for various trace window sizes; and generate a profile of cache miss rate. The profile of cache miss rate is used to determine a working set size of the workload. Other embodiments are also described and claimed.

### TECHNICAL FIELD

The present disclosure relates to the field of computing. More particularly, the present disclosure relates to method and apparatus for determining the working set size for a workload to provide a cache or cache partition of appropriate size for the execution of the workload.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Cache memory of a computing system is a limited resource. The cache miss rate of a workload of one or more applications, threads or programs varies non-linearly with the size of the cache or cache partition provided/allocated for the execution of the workload. A workload having a dedicated/allocated cache (partition) size that is smaller than the working set size often faces a high rate of central processing unit (CPU) stalls, and consumes a much higher memory bandwidth in relation to another workload that's executed with sufficient cache capacity to contain its working set. So, provision/allocation of a cache or cache partition of appropriate size is an important factor for system performance.

The working set size of a workload of one or more applications, threads or programs, is generally considered to be the size of the frequently accessed data of the workload. It is also generally considered to be the optimal size of the amount of cache of a computer system to be required, dedicated or allocated for efficient execution of the workload.

Dynamic optimization, cache load balancing, socket affinitization and efficient multi-latency are example computing technologies that uses the working set size estimate of a workload. However, determining the working set size of a workload, especially a long running workload, is challenging. Current approaches tend to be cumbersome and not very viable for large, long running workloads.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example computer device having the cache/working set size determination technology of the present disclosure, according to various embodiments.

FIG. 2 illustrates the cache manager of FIG. 1 in further details, according to various embodiments.

FIGS. 3-5 illustrate example operational flows of the various components of the example cache manager of FIG. 2, according to various embodiments.

FIG. 6 illustrates determination of memory footprint, according to various embodiments.

FIG. 7 illustrates an example profile of average memory footprint versus trace window-size, and determination of cache miss rates, according to various embodiments

FIG. 8 illustrates an example cache miss rate curve, according to various embodiments.

FIG. 9 illustrates an example process for determining the cache/working set size of a workload, according to various embodiments.

FIG. 10 illustrates an example design-test system having the cache/working set size determination technology of the present disclosure, according to various embodiments.

FIG. 11 illustrates an example computer system suitable for use to practice aspects of the present disclosure, according to various embodiments.

FIG. 12 illustrates a storage medium having instructions for practicing methods described with references to FIGS. 1-10, according to various embodiments.

### DETAILED DESCRIPTION

Software based instrumentation and cache simulation is the most common way for generating the cache miss rate curve which in turn gives the working set size of a workload. Typically, the workload is instrumented to keep track of all memory loads and stores. The load and store addresses are captured to form the memory access trace. The cache behavior (miss rate) is calculated as a function of cache size by running cache simulation for a fully associative cache with the generated trace. The knee in the generated miss rate curve is considered the working set size of the workload.

The cache simulation based technique for finding working set size has at least the following disadvantages:

1. The first step in the cache simulation based technique is to generate the memory access trace by keeping track of all load and store operations. Collecting this data using software instrumentation potentially slows down the workload execution by 10×-100×.

2. The collected memory access trace size (number of addresses in the trace) is huge even for short executions. The complexity of cache simulation is linear in the size of the trace. For the SPEC CPU 2006 benchmarks, the generated trace size is about 20 billion (for 403.gcc) to 2.1 trillion (for 436.cactusADM) operations.

3. Since cache miss rate varies non-linearly with the cache size, the range of cache sizes that need to be explored to find the optimal cache size is unbounded. The method of “running analysis for different cache size till you stumble upon the optimal cache size” is thus very inefficient. For example, the working set size for SPEC CPU 2006 benchmarks varies from an order of 0.1 MB to 100 MB.

Latest advancements in this field have tried to mitigate some of these disadvantages. In one approach by Waldspurger et al, spatial sampling has been employed to address the large trace size issue. [See Carl A. Waldspurger, Nohhyun Park, Alexander Garthwaite, and Irfan Ahmad. 2015. Efficient MRC construction with SHARDS. In Proceedings of the 13th USENIX Conference on File and Storage Technologies (FAST'15). USENIX Association, Berkeley, Calif., USA, 95-110.] In another approach by Xiang, linear-time modeling is employed [See X. Xiang, B. Bao, C. Ding and Y. Gao, “Linear-time Modeling of Program Working Set in Shared Cache,” 2011 International Conference on Parallel Architectures and Compilation Techniques, Galveston, Tex., 2011, pp. 350-360. doi: 10.1109/PACT.2011.66.] In still another approach by Wires et al, the miss rate curve is generated in sub-linear space using probabilistic counters instead of running cache simulation. [See Jake Wires, Stephen Ingram, Zachary Drudi, Nicholas J. A. Harvey, and Andrew Warfield. 2014. Characterizing storage workloads with counter stacks. In Proceedings of the 11th USENIX conference on Operating Systems Design and Implementation (OSDI'14). USENIX Association, Berkeley, Calif., USA, 335-349.] In still another approach by Hu et al, an eviction time based analysis is used to generate the miss rate curve in linear time. [See Xiameng Hu, Xiaolin Wang, Lan Zhou, Yingwei Luo, Chen Ding, and Zhenlin Wang. 2016. Kinetic modeling of data eviction in cache. In Proceedings of the 2016 USENIX Conference on Usenix Annual Technical Conference (USENIX ATC '16). USENIX Association, Berkeley, Calif., USA, 351-364.] While some of these approaches have partially reduced the severities of the trace size and/or the number of cache sizes to be analyzed, tracing overhead remains a major bottleneck.

The present disclosure addresses these disadvantages, and provides for a much more efficient apparatuses, methods and storage medium associated with determining the cache/working set size of a workload. The present invention employs processor event based sampling (PEBS). More specifically, in embodiments, at least one computer-readable storage medium having instructions stored therein to cause an apparatus, in response to execution of the instructions by the apparatus, to: intermittently sample memory access operations, such as load or store operations, associated with execution of a workload; generate a trace of memory addresses of the memory access operations sampled; generate a profile of average memory footprints for various trace window sizes; and generate a profile of cache miss rate.

In some embodiments, generation of a trace of memory addresses of the memory access operations sampled is based at least in part on results of the intermittently sampling of the memory access operations associated with execution of a workload. In some embodiments, generation of a profile of average memory footprints for various trace window sizes is based at least in part on the trace of memory addresses generated. In some embodiments, generation of a profile of cache miss rate is based at least in part on the profile of average memory footprints for various trace window sizes. In some embodiments, the profile of cache miss rate is used to determine a working set size of the workload, and in turn, a cache (partition) of appropriate size for the execution of the workload.

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

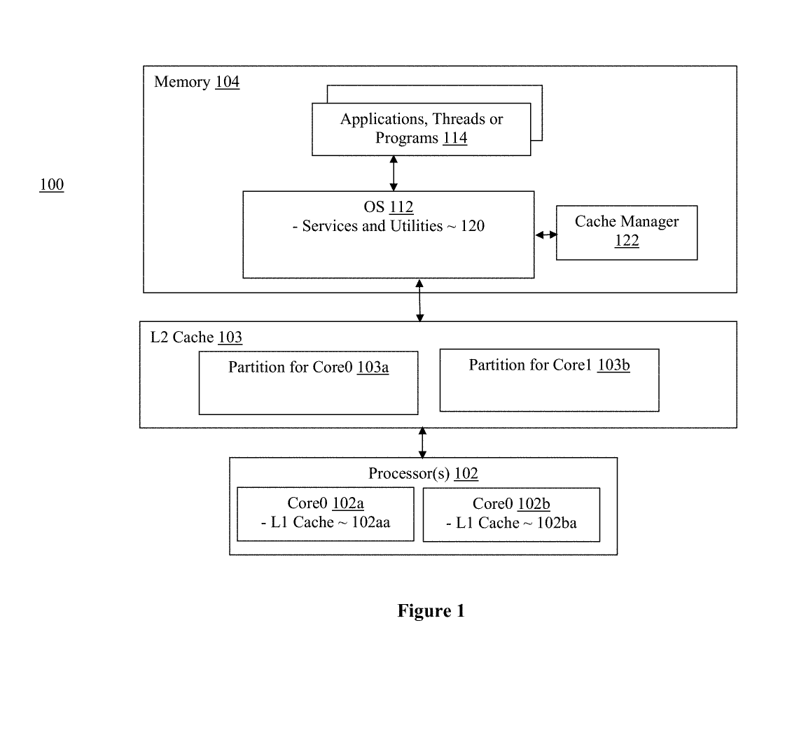

Referring now to FIG. 1, wherein an example computer device having the cache/working set size determination technology of the present disclosure, according to various embodiments, is illustrated. As shown, for the illustrated embodiments, computer device 100 includes multi-core processor 102, cache memory 103 and memory 104, coupled to each other. Multi-core processor 102 includes a number of processor cores (hereinafter, simply cores). For ease of understanding, only 2 cores 102a and 102b are shown. However, the simplified illustration is not to be read as limiting on the present disclosure. Multi-core processor 102 may include many more cores, e.g., 4, 8, 16, 32, 64, 128, 256, and so forth. Further, multi-core processor 102 may include one or more hardware accelerators, e.g., programmable circuits, like field programmable gate arrays (FPGA). For the illustrated embodiments, each of cores 102a and 102b may include its own cache 102aa and 102ba. Thus, cache 102aa and 102ba may be referred to as level 1 (L1) cache, and cache memory 103 may be considered as a level 2 (L2) cache. However, while in practice, it is unlikely that each of cores 102a and 102b would not have an integrated cache, nonetheless, it is anticipated that the cache/working set size determination technology of the present disclosure can be practiced with cores 102a and 102b not having their own integrated L1 caches.

As illustrated, memory 104 stores one or more applications, threads or programs (ATP) 114 executed by processor cores 102a-102b. Memory 104 also stores an operating system (OS) 112, having one or more services or utilities 120, configured to manage the resources of computer device 100, such as allocation and accesses of memory 104, scheduling usage of cores 102a and 102b, and so forth. Additionally, memory 104 includes cache manager 122 configured to partition cache memory 103 into a number of cache partitions, e.g., cache partitions 103a-103b, and respectively allocate/dedicate them for the respective execution of a number of workloads, by the respective cores, e.g., 102a and 102b. Cache manager 122 determines the working set size of a workload, and in turn, uses the determined work set size to determine the size of a cache partition to be created and allocated for the efficient execution of the workload. As described earlier, an undersized cache partition could lead to excessive CPU stalls, inefficient operation of computer device 100. On the other hand, an oversized cache partition would lead to waste or under utilization of the cache resources of computer device 100. Each workload may include one or more ATPs. For ease of understanding, the cache/working set size determination technology will be described with the assumption that each workload is executed by a core, e.g., 102a or 102b. However, the simplified description is not to be construed as limiting. The cache/working set size determination technology may be practiced with each workload being executed by more than one processor core.

Still referring to FIG. 1, cache manager 122 determines the working set size of a workload by determining a cache miss rate profile for the workload. Further, cash manager 122 determines the cache miss rate profile by determining a profile of the average memory footprint for various trace window sizes of the workload. These and other aspects will be described in more detail below.

Except for cache manager 122, computer device 100, including processor 102, cache memory 103, memory 104, ATP 114, OS 112, services and utilities 120, may be any one of these elements known in art. For example, processor 102 may be any x86 multi-core processors from Intel Corporation of Santa, Clara. Cache memory 103 may be any one of a number of high speed, volatile static random access memory with tag circuits. Memory 104 may similarly be any one of a number of dynamic random access memory from manufacturers, such as Micron Technology Inc. of Boise, Id. ATP 114 may be any one of a wide range of user applications, threads or programs, including, but are not limited to, scientific, commercial or software-as-a-service applications. Service and utilities 120 may include, but are not limited to, memory manager, task scheduler, file manager, multi-media player, and so forth. Thus, computer device 100 may be a client device, such as a wearable device, a smartphone, a portable computing device, a computing tablet, a laptop computer, a desktop computer, a set-top box, a camera, a game console, and so forth, an edge/fog computing/networking device, or a cloud computing server.

Before further describing cache manager 122, it should be noted that while for ease of understanding, cache manager 122 has been described as outside of OS 112, executed by processor(s) 102, in some embodiments, cache manager 122, in part or in whole, may be implemented in one or more hardware accelerators within or outside processor(s) 102, as well as being part of OS 112.

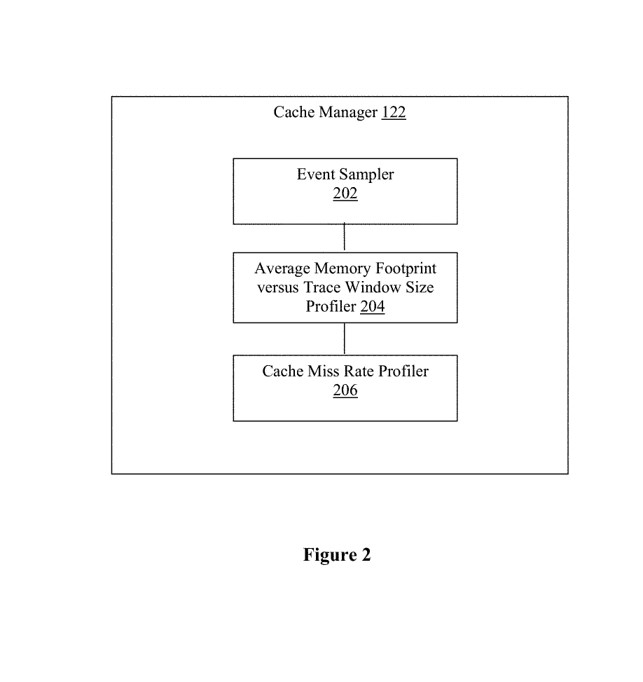

Referring now to FIG. 2, wherein the cache manager of FIG. 1, according to various embodiments, is illustrated. As shown, for the illustrated embodiments, cache manager 122 includes event sampler 202, average memory footprint versus trace window size profiler 204, and cache miss rate profiler 206 coupled to each other as shown. Together, event sampler 202, average memory footprint versus trace window size profiler 204 and cache miss rate profiler 206 cooperate with each other to enable the working set size of a workload to be determined, and in turn, a cache partition of appropriate size to be provided for the workload, based at least in part on the determined working set size.

In various embodiments, event sampler 202 is configured to intermittently or periodically sample the memory access operations, such as load and store operations, of a workload of interest to collect the memory addresses associated with the memory locations accessed by the memory access operations, and generate a trace of the collected memory addresses. For example, event sampler 202 may be configured to periodically sample every n^{th} memory access operation of the workload of interest to collect the memory addresses associated with the memory locations accessed by the memory access operations. N is an integer, such as 10. For this example, the trace would contain the memory address of every n^{th} memory access operation of the workload. As another example, event sampler 202 may be configured to intermittently (pseudo-randomly) sample memory access operations of the workload of interest to collect the memory addresses associated with the memory locations accessed by the memory access operations. In other words, the time distances between successive samplings vary randomly (within a time distance range).

The memory access operations, such as load or store operations, may be intermittently or periodically sampled in any one of a number of ways known in the art. For example, the load or store operations may be intermittently or periodically sampled through monitoring performance monitor unit (PMU) events. In various Intel X86 environments, the load or store operations may be intermittently or periodically sampled through monitoring of one or more events, or combinations thereof, associated with retirements of memory operations, such as, MEM_TRANS_RETIRED.ALL_LOADS_PS and MEM_INST_RETIRED.ALL_STORES events.

Continue to refer to FIG. 2, in various embodiments, average memory footprint versus trace window sample size profiler 204 is configured to determine an average memory footprint versus trace window size profile of the workload, using the intermittent/periodic trace. For a given trace, a trace window of size w starting at element x is defined as the portion of the trace starting at x and containing the next w−1 elements (total w elements). The average memory footprint for a given trace of size n and a given trace window size w is calculated as follows:

$${( Avg fp )}^{w} = \frac{( sum of footprint for all trace windows of size w )}{number of trace windows of size w} \qquad ( 1 )$$

In other words,

$${( Avg fp )}^{w} = \frac{1}{n - w + 1} ( {\sum }_{all windows with size w} {fp}^{w} ) \qquad ( 2 )$$

Consider a trace of size n=5, with 5 samples {s1, s2, s3, s4, and s5}, for trace window size w=3, 3 trace windows of size 3 are possible {s1, s2 and s3}, {s2, s3, and s4}, and {s3, s4, and s5}. Thus, the number of trace windows of size w=3 is n−w+1, or 5−3+1=3.

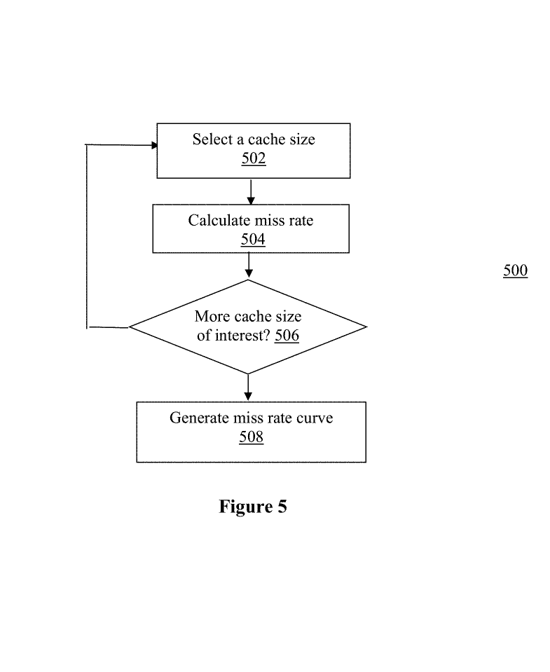

Referring also to FIG. 6, where determination of memory footprint, according to various embodiments, is illustrated. Shown in FIG. 6 is an example scatter gram plot of a number of observed memory access operations. The Y-axis values of the plot are the memory addresses associated with the intermittent or periodic sampled memory access operations of the workload. The X-axis values of the plot are the indices of the samples taken. Each sampled access is represented by a dot 602 in the plot. Each memory address corresponds to a cache line access. The unique memory addresses in a linear memory address range 604 bounding a cluster of the memory addresses sampled, are considered the distinct cache lines 604 accessed. In other words, there might be some unique memory addresses within a linear memory address range 604 where accessed are not observed by the intermittent/periodic trace. Nonetheless, because an intermittent/periodic sampling trace is employed, these not unique memory addresses not observed within the linear memory address range 604 are considered to be accessed anyway. The number of unique memory (cache line) addresses within a liner address range bounding a cluster of memory accesses, and the size of a cache line are used to determine the memory footprint of the workload. More specifically, the memory footprint is equal to the number of distinct cache lines (memory addresses) observed or assumed accessed, times the size of a cache line.

For ease of understanding, only two linear address ranges bounding two clusters of accessed memory addresses are shown. However, it should be noted that in practice, depending on the workload, there might have many more different clusters of memory addresses accessed. In like manner, the memory footprint of a trace window of size w is determined.

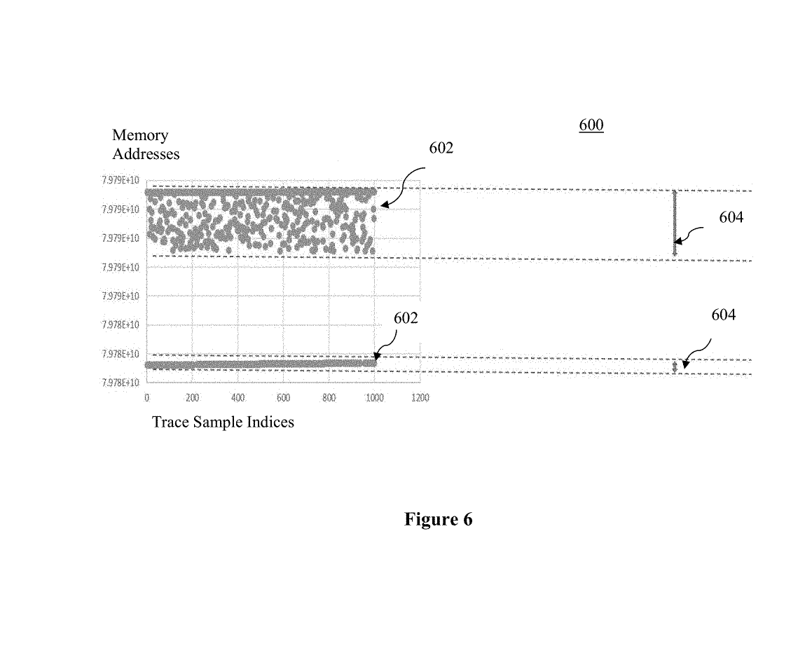

Referring also to FIG. 7, wherein an example profile of average memory footprint versus trace window-size, according to various embodiments, is illustrated. Average memory footprint versus trace window sample size profiler 204 determines profile 700 by iteratively determining the memory footprints of various trace windows of various window sizes, and calculating the average memory footprint for the various window sizes using above equation (1) or (2).

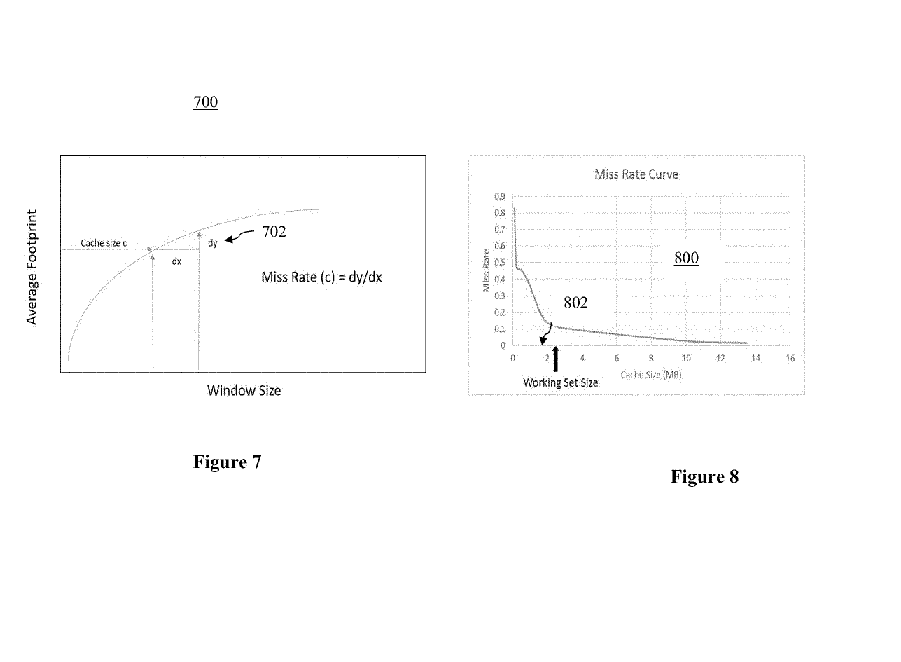

Referring to FIG. 2 again, in various embodiments, cache miss rate profiler 206 is configured to generate a cache miss rate curve/graph of projected cache miss rates for various cache sizes. Cache miss rate profiler 206 determines the projected cache miss rates for various cache sizes by determining the various ratios (dy/dx) 702 of change in the amount of average memory footprint to the amount of change of trace window size for various average memory footprints. An example resulting cache miss rate curve/graph, according to various embodiments, is illustrated in FIG. 8. The various potential cache (or cache partition) sizes correspond to the various average memory footprints in FIG. 7, and the projected cache miss rates correspond to the various ratios 702 determined for the various average memory footprints in FIG. 7.

On establishment of the cache miss rate curve/graph 800 of projected cache miss rates for various cache sizes, the knee 802 of the cache miss rate curve/graph 800 is considered the optimal working set size. Where possible, cache manager 122 creates a cache partition corresponding to the determined working set size, and allocate the cache partition for use to execute the workload.

Before further describing event sampler 202, average memory footprint versus trace window size profiler 204, and cache miss rate profiler 206 of cache manager 202, it should be noted that in some embodiments, sampler 202 and profilers 204 and 206 may be implemented in software. In other embodiments, one or more of sampler 202 and profilers 204 and 206 may be implemented in one or more hardware accelerators or ASIC.

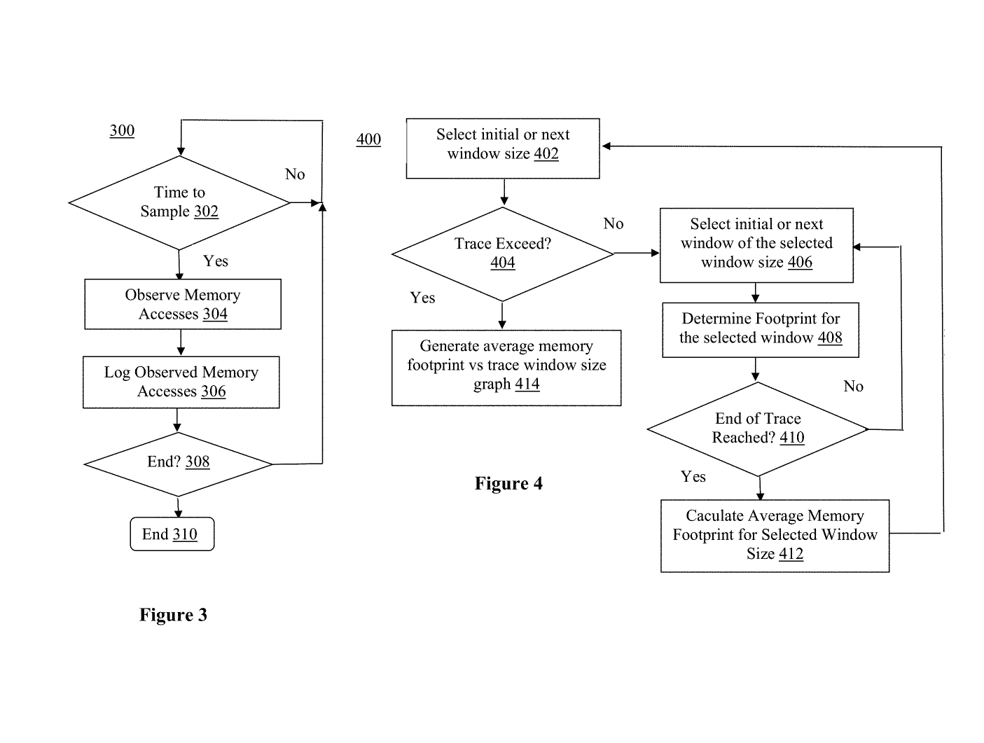

Referring now to FIGS. 3-5, wherein example operational flows of the various components of the example cache manager of FIG. 2, according to various embodiments, are illustrated. In particular, FIG. 3 illustrates an example operation flow of event sampler 202, and FIG. 4 illustrates an example operation flow of average memory footprint versus trace window size profiler 204. FIG. 5 illustrates an example operation flow of cache miss rate profiler 206.

As shown in FIG. 3, for the illustrated embodiments, process 300 for event sampler 202 to intermittently or periodically sample memory access operations of a workload includes operations at blocks 302-310. Starting at block 302, a determination is made on whether it is time to sample a memory access operation to determine the memory address associated with the memory location being accessed. If it is not time to sample, process 300 may loop back to block 302. Eventually, a result of the determination will indicate that it is time to sample the memory access operations.

At such time, process 300 proceeds to block 304. At block 304, the memory addresses associated with the memory access operation is observed. On observation, at block 306, the observed memory address is logged into the memory trace.

At block 308, a determination is made on whether sampling is to continue or end. If a result of the determination indicates that sampling is to continue, process 300 returns to block 302 and continues therefrom as earlier described. If a result of the determination indicates that sampling is to end, process 300 proceeds to block 310 where sampling terminates.

As shown in FIG. 4, for the illustrated embodiments, process 400 for average memory footprint versus trace window size profiler 204 to generate the average memory footprints versus trace window size profile includes operations at blocks 402-414. At block 402, an initial or next trace window size is selected. In various embodiments, the initial trace window size may be a default or user configurable trace window size. At block 404, a determination is made on whether the selected trace window size exceeds the size of the trace. If the selected trace window size does not exceed the size of the trace, process 400 proceeds to block 406, else proceed to block 414.

At block 406, an initial or next trace window of the selected trace window size is selected. At block 408, the memory footprint of the selected trace window of the current selected trace window size is determined. At block 410, a determination is made on whether end of trace has been reached. If end of trace has not been reached, process 400 returns to block 406, and continues therefrom as earlier described. If end of trace has been reached, process 400 proceeds to block 412. At block 412, the average memory footprint for the current selected window size is calculated, as described earlier per equation (1) or (2).

On calculation of the average memory footprint for the current selected window size, process 400 returns to block 402, and selects the next window size, and continues therefrom as earlier described, i.e. proceeds to block 404. In various embodiments, the next window size may be a predetermined or user configurable increment to the previously selected trace window size. Recall at block 404, if the next selected trace window size exceeds the size of the trace, process 400 proceeds to block 414. At block 414, having now calculated the average memory footprint for various trace window sizes, an average memory footprint versus trace window size graph is generated. In various embodiments, a mathematical representation of the graph may be estimated, with the parameters of the mathematical representation stored. In other embodiments, a table storing the various graph values may be created and stored.

As shown in FIG. 5, the example operation flow 500 of cache miss rate profiler 206 includes operations performed at blocks 502-508. At block 502, process 500 selects a cache size of interest. Next at block 504, the cache miss rate for the selected cache size is determined, by calculating the ratio of change in average memory print for a change in trace window size for the corresponding average memory footprint (as described earlier).

Next, at block 506, a determination is made whether there are additional cache sizes to analyze, i.e., determine or estimate their cache miss rates. If there are more cache sizes of interest, process 500 returns to blocks 502, and continues therefrom as earlier described. If all cache sizes of interest have been analyzed, that is having their cache miss rates calculated/estimated, process 500 proceeds to block 508.

At block 508, the cache miss rate curve/graph is generated based on the cache miss rates calculated for the various cache sizes. Similar to the average memory footprint versus trace window size graph, in various embodiments, a mathematical representation of the cache miss rate curve/graph may be estimated, with the parameters of the mathematical representation stored. In other embodiments, a table storing the various cache miss rate curve/graph values may be created and stored.

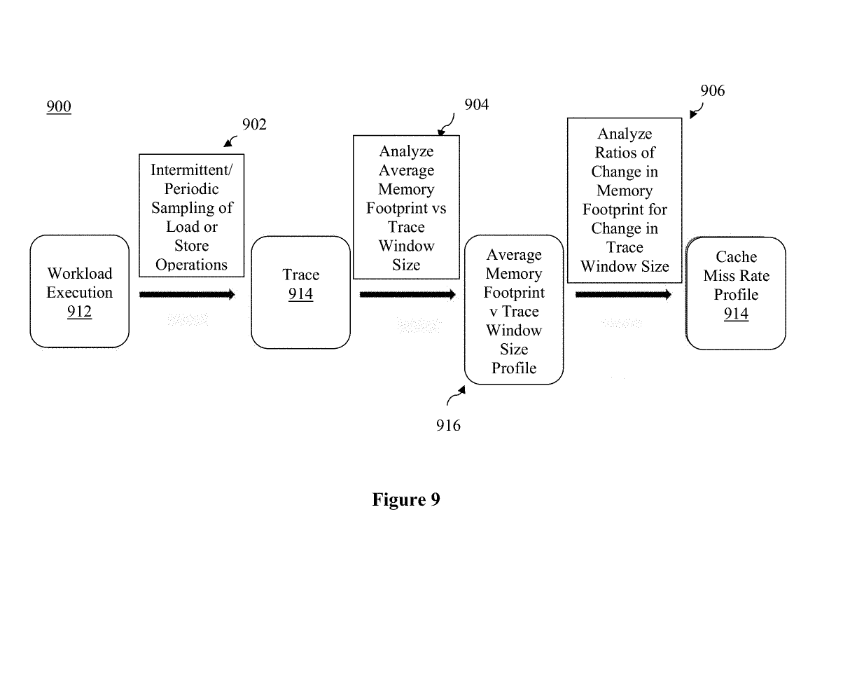

Referring now to FIG. 9, wherein an example process for determining the working set size of a workload, according to various embodiments, is illustrated. As shown, for the illustrated embodiments, process 900 for determining the working set size of a workload includes operations at blocks 902-906. The operations at blocks 902-906 may be performed e.g., by event sampler 202, average memory footprint versus trace window sizes profiler 204 and cache miss rate profiler 206 of cache manager 122 of FIG. 2.

At block 902, intermittent or periodic sampling of memory access operations of a workload 912 being executed, may be performed. The intermittent or periodic sampling results in the trace 914 of some of the memory access operations performed by the execution of the workload 912.

At block 904, the trace is analyzed to determine the average memory footprint versus various trace window sizes, as earlier described. The analysis results in the average memory footprint versus trace window size profile 916.

At block 906, the average memory footprint versus trace window size profile is analyzed for ratios of changes in average memory footprints to changes in trace window sizes, for various average memory footprints. These ratios of the various average memory footprints are equated as estimated cache miss rates of various cache sizes, resulting in cache miss rate profile 914.

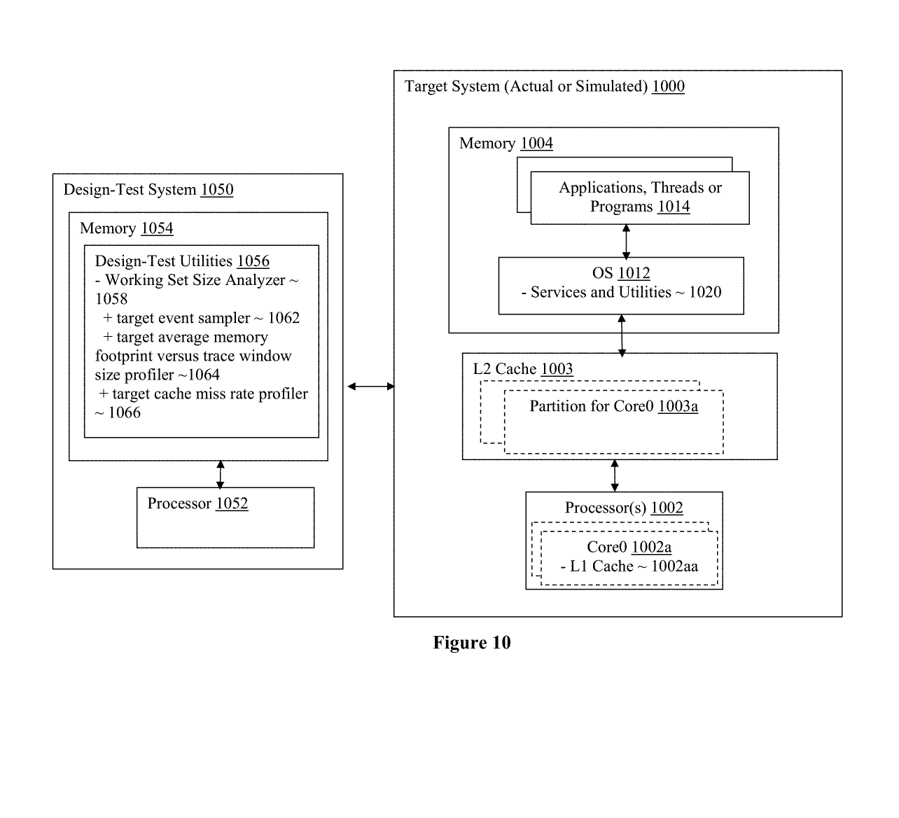

Referring now to FIG. 10, wherein an example design-test system having the cache/working set size determination technology of the present disclosure, according to various embodiments, is illustrated. As illustrated, design-test system 1050 is coupled to a target system 1000, directly or via a local or wide area network. Target system 1000 may be an actual system or a simulated system.

Target system 1000 (actual or simulated) may include processor 1002, cache memory 1003 and memory 1004, similar to the computer device 100 of FIG. 1. That is, processor 1002 may include a number of cores, each may optionally having an integrated L1 cache, e.g., optional core0 1002a, having optional L1 cache 1002aa, and memory 1004 having applications, threads or programs 1014 and OS 1012 with services and utilities 1020.

Design-test system 1050 includes processor 1052 and memory 1054. Memory 1054 includes a number design-test utilities, in particular, working set size analyzer 1058. Working set size analyzer 1058 is configured to determine the working set size of applications, thread, programs 1014, to enable an appropriate size cache 1003 be provided to target system 1000 to execute application, threads or programs 1014. In some embodiments, working set size analyzer 1058 is also configured to determine the working set size of a particular workload having a particular combination of one or more applications, threads, or programs 1014, to enable an appropriate size cache partition 1003a be created and allocated to the execution of the workload on target system 1000.

In various embodiments, working set size analyzer 1058 may be similarly constituted as cache manager 122 of FIGS. 1 and 2, that is, having a target event sampler 1062 similar to event sampler 202, a target average memory footprint versus trace window size profiler 1064 similar to average memory footprint versus trace window size profiler 204, and a target cache miss rate profiler 1066 similar to cache miss rate profiler 206 of FIG. 2. The target event sampler 1062, the target average memory footprint versus trace window size profiler 1064, and the cache miss rate profiler 1066 may be similarly configured to perform the operations of FIGS. 3-5 and 9, as earlier described.

Thus, a novel approach to cache/working set size determination has been described. The technique uses a novel and efficient way of sweeping across a PEBS collection to determine the footprint sizes for various trace window sizes, and in doing so, automatically reflects the locality effects in a cache as a function of the cache size. A further novelty is in determining the cache miss rate at a given footprint by extracting the rate of change in the average memory footprint as a function of the window size used in the sweep over the collected data. By approximating locality in this way, the technique avoids the need for continuous trace collection, and in this way, sidesteps memory tracing and cache simulation that would be otherwise needed.

The below table summarizes the potential benefits comparing the present PEBS analysis to traditional cache simulation based analysis.

| | | Processor Event |
|---|---|---|
| | Cache Simulation Based | Based Sampling |
| | Analysis | (PEBS) Analysis |
| Tracing Slow Down | 10x-100x | <5% |
| Generated Trace | 20 billion (for 403.gcc) to 2.1 | 390 thousand |
| Size (SPEC CPU | trillion (for 436.cactusADM) | (for 403.gcc) to 21 |
| 2006 Benchmark) | | million (for |
| | | 436.cactusADM) |
| Search Space | Unbounded | Bounded |

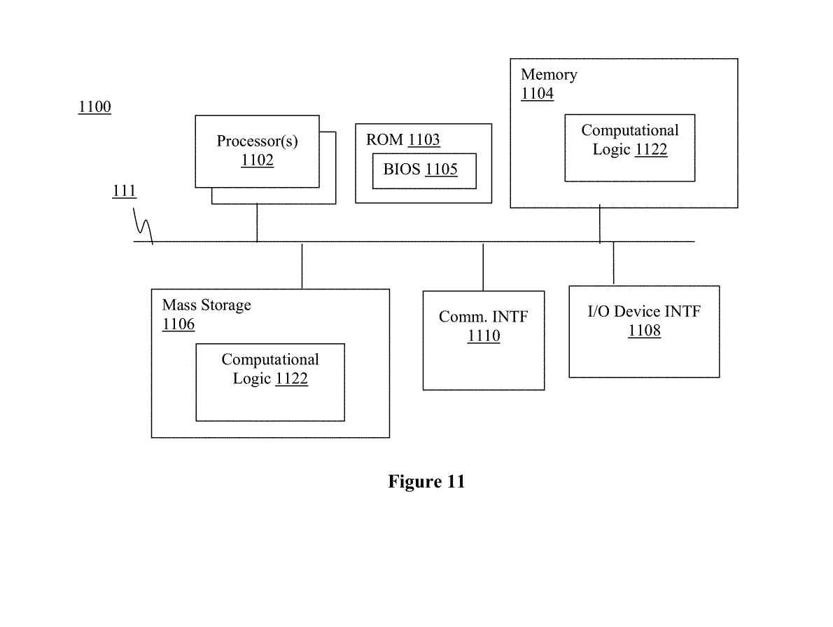

FIG. 11 illustrates an example computer system that may be suitable for use to practice selected aspects of the present disclosure. As shown, computer system 1100 may include one or more processors 1102, each having one or more processor cores, read-only memory (ROM) 1103, and system memory 1104. Processors 1102 may be any one of a number of processors known in the art. Similarly, ROM 1103 may be any one of a number of ROM known in the art, and system memory 1104 may be any one of a number of volatile storage known in the art.

Additionally, computer system 1100 may include mass storage devices 1106. Example of mass storage devices 1106 may include, but are not limited to, tape drives, hard drives, compact disc read-only memory (CD-ROM) and so forth. Further, computer system 1100 may include input/output devices 1108 (such as display, keyboard, cursor control and so forth) and communication interfaces 1110 (such as network interface cards, modems and so forth). Communication interface 1110 may be configured to support one or more communication techniques, including but not limited to, Bluetooth®, Near Field Communication (NFC), WiFi, Cellular communication, LTE, 4G or 5G and so forth. The elements may be coupled to each other via system bus 1112, which may represent one or more buses. In the case of multiple buses, they may be bridged by one or more bus bridges (not shown).

Each of these elements may perform its conventional functions known in the art. In particular, ROM 1103 may include basic input/output system services (BIOS) 1105. System memory 1104 and mass storage devices 1106 may be employed to store a working copy and a permanent copy of the programming instructions implementing the operations associated with applications, threads or programs 114, OS 112, cache manager 122 or working set size analyzer 1058, as earlier described, collectively referred to as computational logic 522. The various elements may be implemented by assembler instructions supported by processor(s) 1102 or high-level languages, such as, for example, C, that can be compiled into such instructions.

The number, capability and/or capacity of these elements 1110-1112 may vary, depending on whether computer system 1100 is used as a mobile device, such as a wearable device, a smartphone, a computer tablet, a laptop and so forth, or a stationary device, such as a desktop computer, an edge/fog networking device, a server, a game console, a set-top box, an infotainment console, and so forth. Otherwise, the constitutions of elements 1110-1112 are known, and accordingly will not be further described.

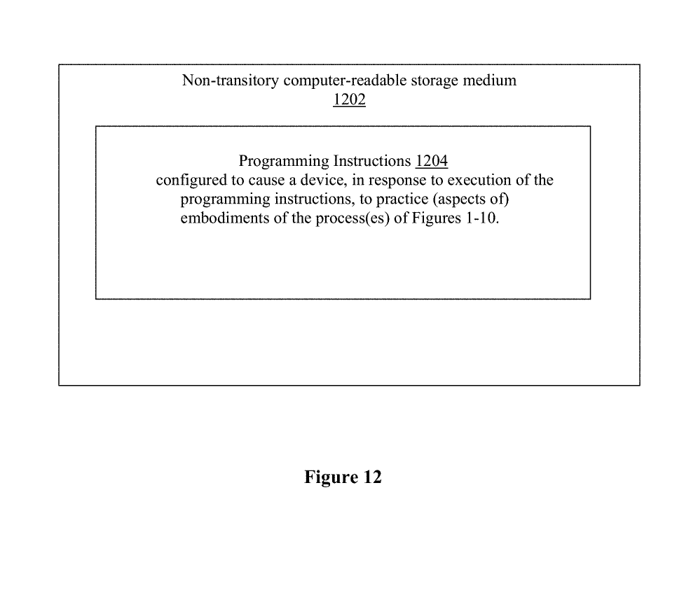

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 12 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1202 may include a number of programming instructions 1204. Programming instructions 1204 may be configured to enable a device, e.g., computer 1100, in response to execution of the programming instructions, to implement (aspects of) applications, thread, or programs 114, OS 112, cache manager 122 or working set size analyzer 1058. In alternate embodiments, programming instructions 1204 may be disposed on multiple computer-readable non-transitory storage media 1202 instead. In still other embodiments, programming instructions 1204 may be disposed on computer-readable transitory storage media 1202, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 11, for one embodiment, at least one of processors 1102 may be packaged together with memory having aspects of computing logic 1122. For one embodiment, at least one of processors 1102 may be packaged together with memory having aspects of computing logic 1122, to form a System in Package (SiP). For one embodiment, at least one of processors 1102 may be integrated on the same die with memory having aspects of computing logic 1122. For one embodiment, at least one of processors 1102 may be packaged together with memory having aspects of computing logic 1122, to form a System on Chip (SoC). For at least one embodiment, the SoC may be utilized in, e.g., but not limited to, a wearable device, a smartphone or a computing tablet.

Thus various example embodiments of the present disclosure have been described including, but are not limited to:

Example 1 is one or more computer-readable storage medium having instructions stored therein to cause an apparatus, in response to execution of the instructions by the apparatus, to: intermittently sample memory access operations associated with execution of a workload; generate a trace of memory addresses of the memory access operations sampled, based at least in part on results of the intermittently sampling of the memory access operations associated with execution of a workload; generate a profile of average memory footprints for various trace window sizes, based at least in part on the trace of memory addresses generated; and generate a profile of cache miss rate, based at least in part on the profile of average memory footprints for various trace window sizes. The profile of cache miss rate is used to determine a working set size of the workload, and in turn, provision of an amount of cache memory, based on the working set size of the workload determined, used to execute the workload.

Example 2 is example 1, wherein to intermittently sample memory access operations associated with execution of a workload comprises to collect a memory address associated with every n^{th} memory access operation of the workload, where n is an integer greater than 1.

Example 3 is example 1, wherein to generate a profile of average memory footprints for various trace window sizes comprises to select a trace window size, and to determine an average memory footprint for a plurality of trace windows of the window size selected.

Example 4 is example 3, wherein to determine an average memory footprint for a plurality of trace windows of the window size selected comprises select a trace window of the selected trace window size, and determine a memory footprint of the selected trace window of the selected trace window size.

Example 5 is example 4, wherein to determine an average memory footprint for a plurality of trace windows of the window size selected further comprises repeating the selection of a trace window of the selected trace window size, and determine a memory footprint of the selected trace window of the selected trace window size, for a plurality of trace windows of the selected trace window size.

Example 6 is example 3, wherein to determine an average memory footprint for the window size selected comprises determining a sum of memory footprints for all trace windows of the window size selected, and divide the sum by the number of trace windows of the window size selected.

Example 7 is example 3, wherein the window size is a first window size, and wherein to generate a profile of average memory footprints for various trace window sizes further comprises to select a second window size that is larger than the first window size, and to determine the average memory footprint for the second window size selected, based at least in part on the trace of memory addresses generated.

Example 8 is example 7, wherein to select a second window size that is larger than the first window size comprises to select the second window size that is of a predetermined increment in size to the first window size.

Example 9 is example 7, wherein to generate a profile of average memory footprints for various trace window sizes further comprises to select a third window size that is larger than the second window size, unless the second window size selected equals a size of the trace of memory addresses generated, and on selection of the third window size, to determine the average memory footprint for the third window size selected, based at least in part on the trace of memory addresses generated.

Example 10 is any one of examples 1-9, wherein to generate a profile of cache miss rate comprises to determine a plurality of cache miss rates at a plurality of average memory footprints.

Example 11 is example 10, and wherein to determine a cache miss rate at an average memory footprint comprises to determine a ratio of an amount of change in average memory footprint to an amount of change in trace window size, for an average memory footprint, using the profile of average memory footprints for various trace window sizes.

Example 12 is example 1-9, wherein the workload comprises one or more applications, threads or programs.

Example 13 is an apparatus for computing, comprising: a processor, a cache memory unit; and a cache manager operated by the processor, the cache manager having: an event sampler to periodically sample memory access operations associated with execution of a workload on the apparatus, and to generate a trace of memory addresses of the memory operations sampled; an average memory footprint versus trace window size profiler coupled to the event sampler to generate a profile of average memory footprints for various trace window sizes; and a cache miss rate profiler coupled with the average memory footprint versus trace window size profiler to generate a profile of cache miss rate. The cache manager uses the profile of cache miss rate to determine a working set size of the workload, and in turn, provides an amount of cache memory, based on the working set size of the workload determined, to execute the workload.

Example 14 is example 13, wherein the processor comprises a plurality of cores, and the workload is executed by one of the plurality of cores; and wherein the cache memory manager determines the working set size of the workload, and partitions the cache memory unit to create a cache partition dedicated to the core executing the workload, based at least in part of the working set size of the workload determined.

Example 15 is example 14, wherein the computing device further comprising an operating system having the cache memory manager.

Example 16 is example 13, wherein the apparatus is a selected one of a client computing device, an edge computing device, a fog networking computing device or a cloud server.

Example 17 is an apparatus for testing, comprising: a processor; and a working set analyzer operated by the processor, having: a target event sampler to periodically sample memory access operations associated with execution of a workload on a target computing device or an emulation of the target computing device, and to generate a trace of memory addresses of the memory operations sampled; a target average memory footprint versus trace window size profiler coupled to the event sampler to generate a profile of average memory footprints for various trace window sizes; and a target cache miss rate profiler coupled with the average memory footprint versus trace window size profiler to generate a profile of cache miss rate. The working set size analyzer uses the profile of cache miss rate to determine a working set size of the workload, and in turn, an amount of cache memory on the target computing device, based on the working set size of the workload determined, to execute the workload.

Example 18 is example 17, wherein the target computing device includes a plurality of cores, and the workload is executed by one of the cores, and wherein the working set size analyzer determines the working set size of the workload, and in turn, a size of a partition of a cache memory unit of the target computing device to be dedicated to the core executing the workload, based at least in part of the working set size of the workload determined.

Example 19 is example 13, wherein the target cache miss rate profiler generates the profile of cache miss rate of the target computing device, based at least in part on the profile of average memory footprints for various trace window sizes of the target computing device.

Example 20 is a method comprising: intermittently sampling memory access operations associated with execution of a workload; generating a trace of memory addresses of the memory access operations sampled, based at least in part on results of the intermittently sampling of the memory access operations associated with execution of a workload; generating a graph of average memory footprints for various trace window sizes, based at least in part on the trace of memory addresses generated; and generating a graph of cache miss rate, based at least in part of the profile of average memory footprints for various trace window sizes. The graph of cache miss rate is used to determine a working set size of the workload, and in turn, provision of an amount of cache memory, based on the working set size of the workload determined, used to execute the workload.

Example 21 is example 20, wherein generating a graph of average memory footprints for various trace window sizes comprises selecting a trace window size, and determining an average memory footprint for a plurality of trace windows of the window size selected.

Example 22 is example 21, wherein determining an average memory footprint for a plurality of trace windows of the window size selected comprises selecting a trace window of the selected trace window size, determining a memory footprint of the selected trace window of the selected trace window size.

Example 23 is example 22, wherein determining an average memory footprint for a plurality of trace windows of the window size selected further comprises repeating the selection of a trace window of the selected trace window size, and determining a memory footprint of the selected trace window of the selected trace window size, for a plurality of trace windows of the selected trace window size.

Example 24 is example 21, wherein determining an average memory footprint for the window size selected comprises determining a sum of memory footprints for all trace windows of the window size selected, and dividing the sum by the number of trace windows of the window size selected.

Example 25 is example 20, wherein generating a profile of cache miss rate comprises determining a plurality of cache miss rates at a plurality of average memory footprints; and wherein determining a cache miss rate at an average memory footprint comprises determining a ratio of an amount of change in average memory footprint to an amount of change in trace window size, for an average memory footprint, using the profile of average memory footprints for various trace window sizes.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. At least one computer-readable storage medium (CRM) having instructions stored therein to cause an apparatus, in response to execution of the instructions by the apparatus, to:
intermittently sample memory access operations associated with execution of a workload;
generate a trace of memory addresses of the memory access operations sampled, based at least in part on results of the intermittently sampling of the memory access operations associated with execution of a workload;
generate a profile of average memory footprints for various trace window sizes, based at least in part on the trace of memory addresses generated; and
generate a profile of cache miss rate, based at least in part on the profile of average memory footprints for various trace window sizes;
wherein the profile of cache miss rate is used to determine a working set size of the workload, and in turn, provision of an amount of cache memory, based on the working set size of the workload determined, used to execute the workload.

2. The CRM of claim 1, wherein to intermittently sample memory access operations associated with execution of a workload comprises to collect a memory address associated with every n^{th} memory access operation of the workload, where n is an integer greater than 1.

3. The CRM of claim 1, wherein to generate a profile of average memory footprints for various trace window sizes comprises to select a trace window size, and to determine an average memory footprint for a plurality of trace windows of the window size selected.

4. The CRM of claim 3, wherein to determine an average memory footprint for a plurality of trace windows of the window size selected comprises select a trace window of the selected trace window size, and determine a memory footprint of the selected trace window of the selected trace window size.

5. The CRM of claim 4, wherein to determine an average memory footprint for a plurality of trace windows of the window size selected further comprises repeating the selection of a trace window of the selected trace window size, and determine a memory footprint of the selected trace window of the selected trace window size, for a plurality of trace windows of the selected trace window size.

6. The CRM of claim 3, wherein to determine an average memory footprint for the window size selected comprises determining a sum of memory footprints for all trace windows of the window size selected, and divide the sum by the number of trace windows of the window size selected.

7. The CRM of claim 3, wherein the window size is a first window size, and wherein to generate a profile of average memory footprints for various trace window sizes further comprises to select a second window size that is larger than the first window size, and to determine the average memory footprint for the second window size selected, based at least in part on the trace of memory addresses generated.

8. The CRM of claim 7, wherein to select a second window size that is larger than the first window size comprises to select the second window size that is of a predetermined increment in size to the first window size.

9. The CRM of claim 7, wherein to generate a profile of average memory footprints for various trace window sizes further comprises to select a third window size that is larger than the second window size, unless the second window size selected equals a size of the trace of memory addresses generated, and on selection of the third window size, to determine the average memory footprint for the third window size selected, based at least in part on the trace of memory addresses generated.

10. The CRM of claim 1, wherein to generate a profile of cache miss rate comprises to determine a plurality of cache miss rates at a plurality of average memory footprints.

11. The CRM of claim 10, and wherein to determine a cache miss rate at an average memory footprint comprises to determine a ratio of an amount of change in average memory footprint to an amount of change in trace window size, for an average memory footprint, using the profile of average memory footprints for various trace window sizes.

12. The CRM of claim 1, wherein the workload comprises one or more applications, threads or programs.

13. An apparatus for computing, comprising:
a processor;
a cache memory unit; and
a cache manager operated by the processor, the cache manager having:
an event sampler to periodically sample memory access operations associated with execution of a workload on the apparatus, and to generate a trace of memory addresses of the memory operations sampled;
an average memory footprint versus trace window size profiler coupled to the event sampler to generate a profile of average memory footprints for various trace window sizes; and
a cache miss rate profiler coupled with the average memory footprint versus trace window size profiler to generate a profile of cache miss rate;
wherein the cache manager uses the profile of cache miss rate to determine a working set size of the workload, and in turn, provides an amount of cache memory, based on the working set size of the workload determined, to execute the workload.

14. The apparatus of claim 13, wherein the processor comprises a plurality of cores, and the workload is executed by one of the plurality of cores; and wherein the cache memory manager partitions the cache memory unit to create a cache partition dedicated to the core executing the workload, based at least in part of the working set size of the workload determined.

15. The apparatus of claim 14, wherein the computing device further comprising an operating system having the cache memory manager.

16. The apparatus of claim 13, wherein the apparatus is a selected one of a client computing device, an edge computing device, a fog networking computing device or a cloud server.

17. An apparatus for testing, comprising:
a processor; and
a working set size analyzer operated by the processor, the working set size analyzer having:
a target event sampler to periodically sample memory access operations associated with execution of a workload on a target computing device or an emulation of the target computing device, and to generate a trace of memory addresses of the memory operations sampled;
a target average memory footprint versus trace window size profiler coupled to the event sampler to generate a profile of average memory footprints for various trace window sizes; and
a target cache miss rate profiler coupled with the average memory footprint versus trace window size profiler to generate a profile of cache miss rate;
wherein the working set size analyzer uses the profile of cache miss rate to determine a working set size of the workload, and in turn, determine an amount of cache memory to be allocated on the target computing device, based on the working set size of the workload determined, to execute the workload.

18. The apparatus of claim 17, wherein the target computing device comprises a plurality of cores, and the workload is executed by one of the plurality of cores; wherein the working set size analyzer determines a size of a partition of a cache memory unit of the target computing device to be dedicated to the core executing the workload, based at least in part of the working set size of the workload determined.

19. The apparatus of claim 18, wherein the target cache miss rate profiler generates the profile of cache miss rate for the target computing device, based at least in part on the profile of average memory footprints for various trace window sizes for the target computing device;

20. A method comprising:
intermittently sampling memory access operations associated with execution of a workload;
generating a trace of memory addresses of the memory access operations sampled, based at least in part on results of the intermittently sampling of the memory access operations associated with execution of a workload;
generating a graph of average memory footprints for various trace window sizes, based at least in part on the trace of memory addresses generated; and
generating a graph of cache miss rate, based at least in part of the profile of average memory footprints for various trace window sizes;
wherein the graph of cache miss rate is used to determine a working set size of the workload, and in turn, provision of an amount of cache memory, based on the working set size of the workload determined, used to execute the workload

21. The method of claim 20, wherein generating a graph of average memory footprints for various trace window sizes comprises selecting a trace window size, and determining an average memory footprint for a plurality of trace windows of the window size selected.

22. The method of claim 21, wherein determining an average memory footprint for a plurality of trace windows of the window size selected comprises selecting a trace window of the selected trace window size, determining a memory footprint of the selected trace window of the selected trace window size, and.

23. The method of claim 22, wherein determining an average memory footprint for a plurality of trace windows of the window size selected further comprises repeating the selection of a trace window of the selected trace window size, and determining a memory footprint of the selected trace window of the selected trace window size, for a plurality of trace windows of the selected trace window size.

24. The method of claim 21, wherein determining an average memory footprint for the window size selected comprises determining a sum of memory footprints for all trace windows of the window size selected, and dividing the sum by the number of trace windows of the window size selected.

25. The method of claim 20, wherein generating a profile of cache miss rate comprises determining a plurality of cache miss rates at a plurality of average memory footprints; and wherein determining a cache miss rate at an average memory footprint comprises determining a ratio of an amount of change in average memory footprint to an amount of change in trace window size, for an average memory footprint, using the profile of average memory footprints for various trace window sizes.
